(19) United States
(12) Patent Application Publication
(10) Pub. No.: US 2001/0003491 A1
(43) Pub. Date: Jun. 14, 2001

(54) Optical pickup using laser beams of plural different wavelengths

(75) Inventor: Shoichi Kyoya, Miyagi-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 09/731,116

(22) Filed: Dec. 6, 2000

(30) Foreign Application Priority Data
Dec. 13, 1999 (JP) 11-352844

(51) Int. Cl. G02B 27/14

(52) U.S. Cl. 359/629; 359/634; 359/636

(57) ABSTRACT

The optical pickup includes a two-wavelength laser diode having two light sources that emit a laser beam for the DVD and a laser beam for the CD, a light-receiving member, and a beam splitter. The beam splitter is provided with a wavelength-separating layer composed of a first and a second interfaces and an optical thin plate between the interfaces, having a specific refractive index n2. The first and second interfaces each have a first and a second wavelength selecting films coated thereon, which reflect or permeate the laser beams each by the specific rates, bring the optical axes of the laser beams after having reflected on the first and second interfaces into coincidence, permit the laser beams to go out of the beam splitter, and make the return beams from the optical disks permeate through the wavelength-separating layer to guide them toward the light-receiving member.

### BACKGROUND OF THE INVENTION

1. Field of the Invention

The present invention relates to an optical pickup that irradiates light beams to an optical disk and receives light beams returned from the optical disk in order to record or reproduce data to and from the optical disk.

2. Description of the Related Art

Optical pickups are used for recording information on optical disks such as a CD (Compact Disk), CD-R (Write Once CD), DVD (Digital Versatile Disk or Digital Video Disk), or for reproducing information recorded on the optical disks.

In Recent years, DVD drives have been put on the market, which record and reproduce DVDs having higher recording density than CDs. The DVD drive is required to have compatibility with the CD (including CD-R) . Accordingly, the DVD drive has been required to have two laser sources of different wavelengths: a laser source (wavelength 650 nm) for DVD and another laser source (wavelength 780 nm) for CD-R to record and reproduce a CD-R that the laser source of the 650 nm band cannot reproduce.

FIG. 4 illustrates an optical system 30 of a conventional optical pickup as the first conventional example; FIG. 5 illustrates an optical system 50 of a conventional optical pickup as the second conventional example; and FIG. 6 illustrates an optical system 70 of a conventional optical pickup as the third conventional example.

First, a one-wavelength optical system that handles only one wavelength exclusive for the CD will be described with reference to FIG. 4.

In the optical system 30, 31 denotes a cubic beam splitter, and a light-receiving lens 32 and a light-receiving member 33 incorporating a light-receiving element (not illustrated) are disposed on one axis with a specific distance on one side of the beam splitter 31. Further, on the other side of the beam splitter 31 opposite to the light-receiving lens 32 is disposed a reflecting mirror 34.

Further, a diffraction grating 35 and a laser diode 36 for the CD 61 are coaxially disposed underneath the beam splitter 31, in a direction perpendicular to the optical axis connecting the light-receiving member 33 and the reflecting mirror 34. Further, a collimating lens 37 and an objective lens 38 are coaxially disposed above the reflecting mirror 34. Further, these optical members are mounted on a carriage not illustrated, and the like. The CD 61 is illustrated only partially in the drawing, which is the same in the following drawings.

Next, the reproducing operation of the CD 61 will be described.

When reproducing the CD 61, a laser beam of a wavelength 780 nm that the laser diode 36 emits passes through the diffraction grating 35. Then, the laser beam with three beams formed by the diffraction grating 35 falls on the beam splitter 31. Further, the laser beam fallen on the beam splitter 31 reflects to deflect the angle by 90° and goes out to the reflecting mirror 34.

The laser beam reflects upward to deflect the angle by 90° on the reflecting mirror 34, and falls on the collimating lens 37 disposed above the reflecting mirror 34. The laser beam collimated by the collimating lens 37 falls on the objective lens 38. The objective lens 38 condenses the laser beam to form an image on the face of the CD 61 where data are recorded.

Thereafter, the laser beam (return beam) reflected on the CD 61 transmits again through the objective lens 38 and the collimating lens 37, after reflecting on the reflecting mirror 34, transmits through the beam splitter 31, and falls on the light-receiving lens 32. The light-receiving lens 32 transforms the return beam into an optimum spot for the light-receiving element inside the light-receiving member 33 to receive, and then the return beam falls on the light-receiving member 33. Here, the return beam received is converted into electricity by the light-receiving element, where a current output according to the signal on the data record face of the CD 61 is converted into a voltage signal, which is outputted as a reproduction signal from an external terminal not illustrated. Part of the return beam received by the light-receiving element is used for the focusing control and the tracking control by the three-beam method.

Thus, in the first conventional example, since the optical system 30 using the laser diode 36 that emits a laser beam of one wavelength can be made up mainly with one beam splitter and a light-receiving member having one light-receiving element, the construction is simplified. Further, in regard to the adjustment of the optical system 30, it is only needed to align the light-receiving member 33 so that the light-receiving element can receive the return beam from the CD 61 at the optimum position, and the adjustment is simple accordingly.

Next, a conventional example of a two-wavelength optical system that handles two wavelengths for the CD and the DVD will be described with reference to FIG. 5.

In the optical system 50, 51 denotes a first cubic beam splitter; anda second cubic beam splitter 52, a light-receiving lens 53, and a light-receiving member 54 incorporating a light-receiving element (not illustrated) are disposed on one axis with a specific distance on one side of the beam splitter 51. Further, on the other side of the first beam splitter 51 opposite to the second beam splitter 52 is disposed a reflecting mirror 55.

Further, a diffraction grating 56 and a laser diode 57 for the CD 61 are coaxially disposed underneath the first beam splitter 51, in a direction perpendicular to the optical axis connecting the light-receiving member 54 and the reflecting mirror 55. Further, a laser diode 58 for the DVD 62 is disposed above the second beam splitter 52, further a collimating lens 59 and an objective lens 60 are coaxially disposed above the reflecting mirror 55. Here, the objective lens 60 has a configuration that permits to handle the laser beams of two different wavelengths for the CD 61 and the DVD 62. Further, these optical members are mounted on a carriage not illustrated, and the like. The CD 61 (DVD 62) is illustrated only partially in the drawing, which is the same in the following drawings.

Next, the reproducing operation of the CD 61 and the DVD 62 will be described.

When reproducing the CD 61, a laser beam of a wavelength 780 nm that the laser diode 57 emits passes through the diffraction grating 56. Then, the laser beam with three beams formed by the diffraction grating 56 falls on the first beam splitter 51. Further, the laser beam fallen on the first beam splitter 51 reflects to deflect the angle by 90° and goes out to the reflecting mirror 55.

The laser beam reflects upward to deflect the angle by 90° on the reflecting mirror 55, and falls on the collimating lens 59 disposed above the reflecting mirror 55. The laserbeam collimated by the collimating lens 59 falls on the objective lens 60. The objective lens 60 condenses the laser beam to form an image on the face of the CD 61 where data are recorded.

Thereafter, the laser beam (return beam) reflected on the CD 61 transmits again through the objective lens 60 and the collimating lens 59, after reflecting on the reflecting mirror 55, transmits through the first beam splitter 51 and the second beam splitter 52, and falls on the light-receiving lens 53. The light-receiving lens 53 transforms the return beam into an optimum spot for the light-receiving element inside the light-receiving member 54 to receive, and then the return beam falls on the light-receiving member 54. Here, the return beam fallen on the light-receiving member 54 is converted into electricity by the light-receiving member 54, where a current output according to the signal on the data record face of the CD 61 is converted into a voltage signal, which is outputted as a reproduction signal from an external terminal not illustrated. Part of the return beam fallen on the light-receiving member 54 is used for the focusing control and the tracking control by the three-beam method.

Next, when reproducing the DVD 62, a laser beam of a wavelength 650 nm that the laser diode 58 emits falls on the second beam splitter 52. Further, the laser beam fallen on the second beam splitter 52 reflects to deflect the angle by 90° on the second beam splitter 52, passes through the first beam splitter 51 disposed adjacently, and falls on the reflecting mirror 55.

The laser beam reflects upward to deflect the angle by 90° on the reflecting mirror 55, and falls on the collimating lens 59 disposed above the reflecting mirror 55. The laser beam collimated by the collimating lens 59 falls on the objective lens 60. The objective lens 60 condenses the laser beam to form an image on the face of the DVD 62 where data are recorded.

Thereafter, the laser beam (return beam) reflected on the DVD 62 transmits again through the objective lens 60 and the collimating lens 59, after reflecting on the reflecting mirror 55, transmits through the first beam splitter 51 and the second beam splitter 52, and falls on the light-receiving lens 53. After the light-receiving lens 53 transforms the return beam into an optimum spot for the light-receiving member 54 to receive, the return beam falls on the light-receiving member 54. Here, the return beam fallen on the light-receiving member 54 is converted into electricity by the light-receiving member 54, where a current output according to the signal on the data record face of the DVD 62 is converted into a voltage signal, which is outputted as a reproduction signal from an external terminal not illustrated. Part of the return beam fallen on the light-receiving member 54 is used for the focusing control and the tracking control.

Thus, the second conventional example mainly employs laser diodes 57, 58 of two different wavelengths, and the first and second beam splitters 51, 52 having a function that guides the laser beams that the laser diodes 57, 58 each emit to one and the same optical path for the CD 61 and the DVD 62, and guides the return beams each to the light-receiving member 54 so that each of them can be received by one light-receiving element, thereby achieving the two-wavelength optical system.

Next, another conventional example of a two-wavelength optical system that handles two wavelengths for the CD and the DVD will be described with reference to FIG. 6.

In the drawing, 71 denotes a cubic beam splitter, and a light-receiving lens 72 and a light-receiving member 73 incorporating a light-receiving element (not illustrated) are disposed on one axis with a specific distance on one side of the beam splitter 71. Further, on the other side of the beam splitter 71 opposite to the light-receiving lens 72 is disposed a reflecting mirror 74.

Further, a diffraction grating 75 and a two-wavelength laser diode 76 that emits laser beams of two different wavelengths, which are a laser beam 76a for the CD 61 and a laser beam 76b for the DVD 62, are coaxially disposed underneath the beam splitter 71, in a direction perpendicular to the optical axis connecting the light-receiving member 73 and the reflecting mirror 74. Further, a collimating lens 77 and an objective lens 78 are coaxially disposed above the reflecting mirror 74. Here, the objective lens 78 has a configuration that permits to handle the laser beams of two different wavelengths for the CD 61 and the DVD 62. Further, these optical members are mounted on a carriage not illustrated, and the like.

The two-wavelength laser diode 76 contains two light sources, namely, two laser diode chips (not illustrated) for the CD 61 and the DVD 62, disposed adjacently with a specific spacing, in which the laser diode chips are set such that the laser beams 76a, 76b that the laser diode chips each emit become mutually parallel. Further, in the manufacturing process of the two-wavelength laser diode 76, since a process resembling the semiconductor manufacturing process processes the two laser diode chips on a substrate, the spacing between the laser diode chips can easily be formed uniformly precisely with a specific value. Accordingly, the two-wavelength laser diode can be manufactured in large quantities as a discrete component, and the cost thereof can be reduced.

Next, the reproducing operation of the CD 61 and the DVD 62 will be described.

When reproducing the CD 61, the laser beam 76a of a wavelength 780 nm that the two-wavelength laser diode 76 emits passes through the diffraction grating 75. Then, the laser beam 76a with three beams formed by the diffraction grating 75 falls on the beam splitter 71. Further, the laser beam 76a fallen on the beam splitter 71 reflects to deflect the angle by 90° and goes out to the reflecting mirror 74.

The laser beam 76a reflects upward to deflect the angle by 90° on the reflecting mirror 74, and falls on the collimating lens 77 disposed above the reflecting mirror 74. The laser beam 76a collimated by the collimating lens 77 falls on the objective lens 78. The objective lens 78 condenses the laser beam to form an image on the face of the CD 61 where data are recorded.

Thereafter, the laser beam (return beam) 76a reflected on the CD 61 transmits again through the objective lens 78 and the collimating lens 77, after reflecting on the reflecting mirror 74, transmits through the beam splitter 71, and falls on the light-receiving lens 72. The light-receiving lens 72 transforms the return beam 76a into an optimum spot for one light-receiving element of the two light-receiving elements inside the light-receiving member 73 to receive, and then the return beam falls on the light-receiving member 73. Here, the return beam 76a received is converted into electricity by the one light-receiving element, where a current output according to the signal on the data record face of the CD 61 is converted into a voltage signal, which is outputted as a reproduction signal from an external terminal not illustrated. Part of the return beam 76a received by the one light-receiving element is used for the focusing control and the tracking control by the three-beam method.

Next, when reproducing the DVD 62, a laser beam 76b of a wavelength 650 nm that the two-wavelength laser diode 76 emits, which is in parallel with the optical axis of the laser beams 76a with a specific distance, transmits through the diffraction grating 75, and falls on the beam splitter 71. Further, the laser beam 76b fallen on the beam splitter 71 reflects to deflect the angle by 90° on the beam splitter 71, and falls on the reflecting mirror 74.

The laser beam 76b reflects upward to deflect the angle by 90° on the reflecting mirror 74, and falls on the collimating lens 77 disposed above the reflecting mirror 74. The laser beam 76b collimated by the collimating lens 77 falls on the objective lens 78. The objective lens 78 condenses the laser beam to form an image on the face of the DVD 62 where data are recorded.

Thereafter, the laser beam (return beam) 76b reflected on the DVD 62 transmits again through the objective lens 78 and the collimating lens 77, maintaining a specific spacing with the return beam 76a from the CD 61. After reflecting on the reflecting mirror 74, the return beam 76b transmits through the beam splitter 71, and falls on the light-receiving lens 72. After the light-receiving lens 72 transforms the return beam 76b into an optimum spot for the other light-receiving element inside the light-receiving member 73 to receive, the return beam falls on the light-receiving member 73. Here, the return beam 76b received is converted into electricity by the other light-receiving element, where a current output according to the signal on the data record face of the DVD 62 is converted into a voltage signal, which is outputted as a reproduction signal from an external terminal not illustrated. Part of the return beam 76b received by the other light-receiving element is used for the focusing control and the tracking control.

Thus, the third conventional example mainly employs one two-wavelength laser diode 76, one beam splitter 71 having a function that guides the laser beams 76a, 76b emitted in parallel with each other by the two-wavelength laser diode 76 to the CD 61 and the DVD 62, and guides the return beams each to the light-receiving member 73, and the light-receiving member 73 incorporating two light-receiving elements each corresponding to the laser beams 76a, 76b of different wavelengths; thereby achieving the two-wavelength optical system.

However, in the second conventional example as shown in FIG. 5, it is possible to employ the laser diodes 57, 58 being comparably inexpensive discrete components, on the other hand, it is necessary to align the position of the light-receiving member 54 to the position where the laser diode 58 for the DVD is disposed, and to adjust the light-receiving member 54 in the optical axis direction so as to focus the return beam coming in from the light-receiving lens 53 toward the light-receiving member 54 on the light-receiving element inside the light-receiving member 54. Besides, since one light-receiving element has to receive the laser beams for both the CD and the DVD, the position alignment of the laser diode 57 has to be carried out precisely after the foregoing alignment in such a manner that the position of the laser diode 57 is equivalent to that of the laser diode 58, which increases the alignment processes that require preciseness and skillfulness and increases the cost for the alignment accompanied therewith. Further, since it is manufactured through many precise processes, the beam splitter is comparably expensive optical element, and this conventional example needs two beam splitters 52, 52 corresponding to the laser diodes 57, 58 each, thereby leading to cost increase of the optical pickup, which is disadvantageous. Also, since this example employs two laser diodes 57, 58 and two beam splitters 51, 52 corresponding to the laser diodes 57, 58 each, the structure becomes complicated compared with the one-wavelength optical system 30 as shown in FIG. 4, which is a problem.

On the other hand, the third conventional example employs the one two-wavelength laser diode 76 and the one beam splitter 71, which makes it possible to reduce the number of the components compared with the second conventional example as shown in FIG. 5, and to use an inexpensive two-wavelength laser diode, which is advantageous. However, two light-receiving elements have to be formed inside the light-receiving member 73 in order to receive the mutually parallel return beams 76a, 76b with a specific spacing, and the number of the external terminals furnished with the light-receiving member is inevitably increased in order to connect to these light-receiving elements from the outside, which makes the connection to the circuit boards complicated and the handling uneasy, which is disadvantageous. Further, in the third conventional example, since it is impossible to use the light-receiving members containing one light-receiving element as shown in FIG. 4 and FIG. 5, which are generally used in many optical pickups, the special light-receiving member having the two-light-receiving elements has to be manufactured separately from these, and the unit cost of the light-receiving member increases to raise the cost of the optical pickup, which is a problem.

### SUMMARY OF THE INVENTION

The present invention has been made in view of the foregoing circumstances, and it is an object of the invention to provide an optical pickup that simplifies the optical system, simplifies the alignment processes, and reduces the manufacturing cost.

According to one aspect of the invention, the optical pickup includes: a light-emitting part having plural light sources that emit laser beams of which wavelengths are different and optical axes are mutually parallel with a specific distance; a light-receiving member having a light-receiving element; and a beam splitter that admits the laser beams, delivers the laser beams toward optical disks, and guides return beams from the optical disks toward the light-receiving member where the light-receiving element receives the return beams. The beam splitter is provided with a wavelength-separating layer, and the wavelength-separating layer is comprised of two interfaces and a medium having a specific refractive index, placed between the interfaces, or more than three interfaces and media each having specific refractive indexes, placed between the interfaces. In this construction, the beam splitter reflects or permeates the laser beams at or through the interfaces, brings the optical axes of the laser beams after reflection into coincidence, delivers the laser beams out of the beam splitter, and permeates the return beams through the wavelength-separating layer to guide them toward the light-receiving member. Thereby, in the optical system using the light-emitting part having plural light sources, it is possible to bring the optical axes of the laser beams into coincidence by one beam splitter, to make the laser beams go out toward the optical disks from the beam splitter, and to thereby bring the optical axes of the return beams from the optical disks into coincidence. Therefore, it becomes possible to receive the return beams by one light-receiving element, to employ the widely generally used light-receiving member furnished with one light-receiving element as the light-receiving member, and accordingly to simplify the optical system using plural wavelengths into the same level as the one-wavelength optical system exclusive for the CD. Further, this system needs only one beam splitter, and it can employ the conventional light-receiving member, thus reducing the cost. Further, the position alignment of the light-receiving member is only needed for the alignment of the optical system, which simplifies the alignment process as well.

According to another aspect of the invention, the light-emitting part has two light sources that emit a first laser beam having a first wavelength and a second laser beam having a second wavelength, the wavelength-separating layer has a first interface and a second interface, the first and the second interfaces each have a first and a second wavelength selecting films formed thereon, which reflect or permeate the first and the second laser beams each by specific rates, the first interface reflects the first laser beam and permeates the second laser beam, the second interface reflects the second laser beam, and the first and the second interfaces permeate the first and the second laser beams with regard to the return beams. Thereby, the optical system can be applied, for example, to an optical pickup for two wavelengths that can record or reproduce both the DVD and the CD (CD-R). Further, the wavelength-separating layer separates the first laser beam and the second laser beam and reflects them on the first interface and the second interface, which permits an efficient use of the laser beams.

According to another aspect of the invention, the first wavelength selecting film reflects the first laser beam approximately by 50%, permeates it approximately by 50%, and permeates the second laser beam almost by 100%, and the second wavelength selecting film permeates the first laser beam almost by 100%, reflects the second laser beam approximately by 50%, and permeates it approximately by 50%. Thereby, the first laser beam and the second laser beam can be separated in a well-balanced state, and the laser beams can be used more efficiently.

According to another aspect of the invention, the light-emitting part has two light sources that emit the first laser beam having the first wavelength and the second laser beam having the second wavelength, the wavelength-separating layer has the first interface and the second interface, and the first and the second interfaces each have a first and a second polarization separating films formed thereon, which reflect and permeate the first and the second laser beams in accordance with the polarization states thereof. Thereby, the optical system can be applied, for example, to an optical pickup for two wavelengths that can record or reproduce both the DVD and the CD (CD-R) . Further, the polarization separating films separate the first laser beam and the second laser beam and reflect them on the first interface and the second interface, which permits an efficient use of the laser beams.

According to another aspect of the invention, the beam splitter is composed of an optical plate and the wavelength-separating layer formed on the optical plate. Thereby, the wavelength-separating layer can be formed on the optical plate that a comparably simple process can easily form with a high precision.

According to another aspect of the invention, the light-emitting part is a light-emitting member contained plural in one package. Thereby, a process resembling the semiconductor manufacturing process can process the light sources, and the light-emitting member can be manufactured in large quantities as a discrete component.

According to another aspect of the invention, a diffraction grating is disposed between the light-emitting member and the beam splitter. Thereby, the laser beam can be transformed into the three beams, and the optical system can adopt the three-beams-tracking control being a suitable servo control for recording or reproducing the CD (CD-R).

According to another aspect of the invention, the light-emitting member and the beam splitter each are fastened to a carriage separately, the interfaces are parallel with each other, the light-emitting member is placed in such a manner that the light sources are in a parallel direction with the surfaces of the optical disk, and the beam splitter is disposed in such a manner that the incident angles of the laser beams on the interfaces are virtually 45°. Thereby, the optical system using plural light sources can be made up mainly with one light-emitting member, one beam splitter, and one light-receiving member, and the optical system can take on the same configuration as the one-wavelength optical system using one light source exclusive for the CD, and the optical system can be simplified accordingly.

### BRIEF DESCRIPTION OF THE DRAWINGS

FIG. 1 illustrates an embodiment of an optical system 100 of an optical pickup relating to the invention;

FIG. 2 is a partially sectional view illustrating a two-wavelength laser diode 102 of the optical pickup in the embodiment relating to the invention;

FIG. 3 is a partially enlarged view of the part 3 of the optical pickup in FIG. 1 in the embodiment relating to the invention;

FIG. 4 illustrates an optical system 30 of a conventional optical pickup in the first conventional example;

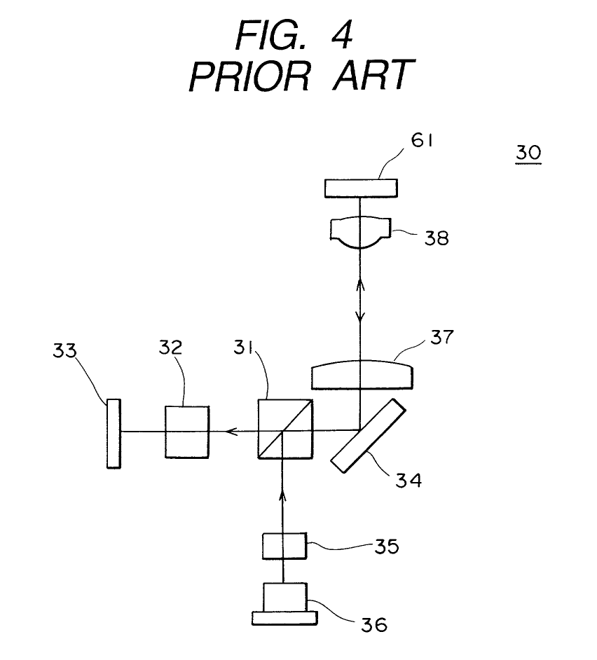

FIG. 5 illustrates an optical system 50 of a conventional optical pickup in the second conventional example; and

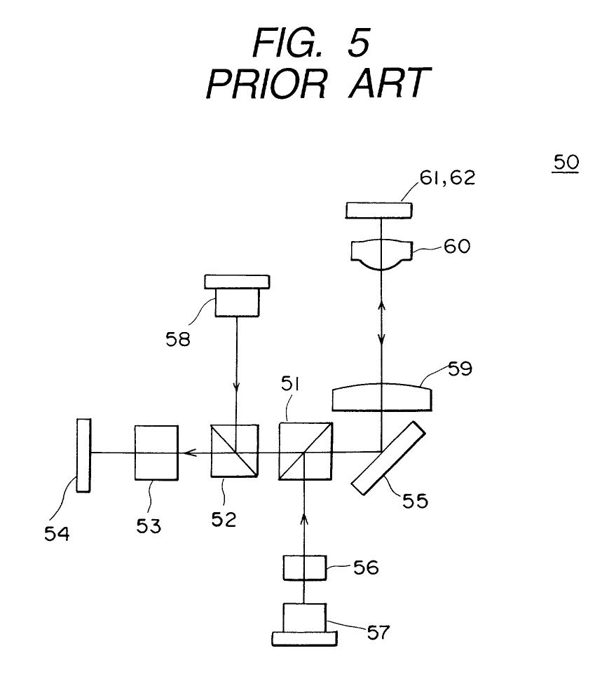

FIG. 6 illustrates an optical system 70 of a conventional optical pickup in the third conventional example.

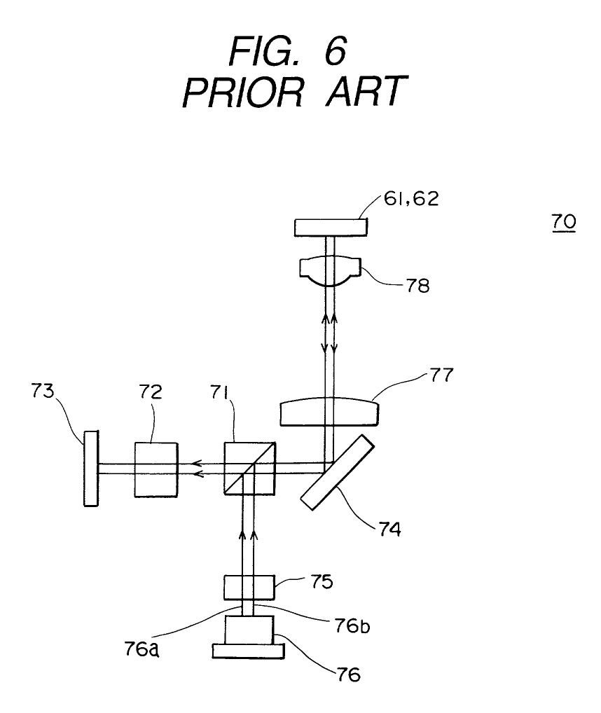

### DETAILED DESCRIPTION OF THE PREFERRED EMBODIMENT

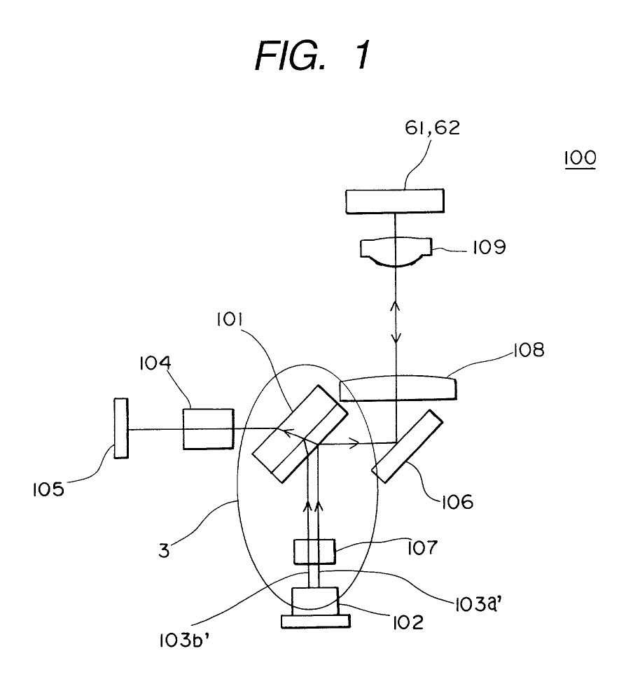

The preferred embodiment relating to the optical pickup of the invention will be described with reference to FIG. 1 through FIG. 3.

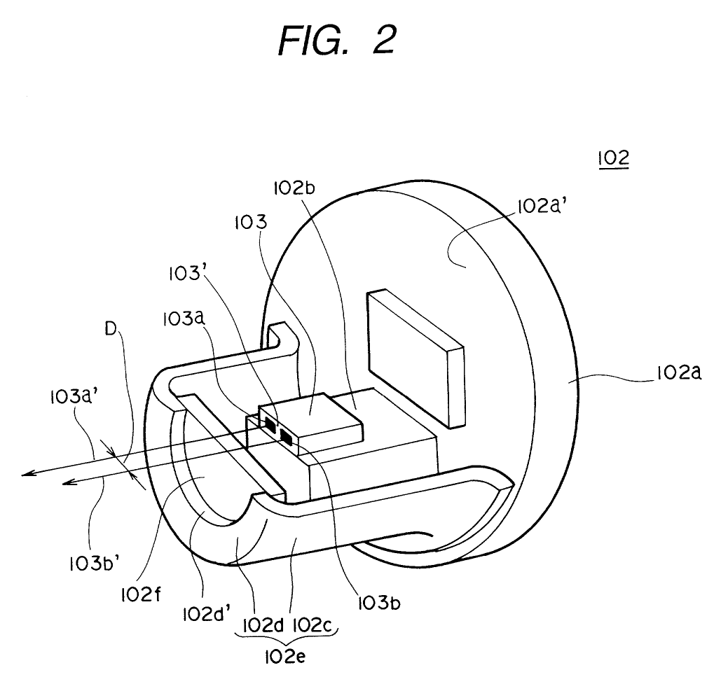

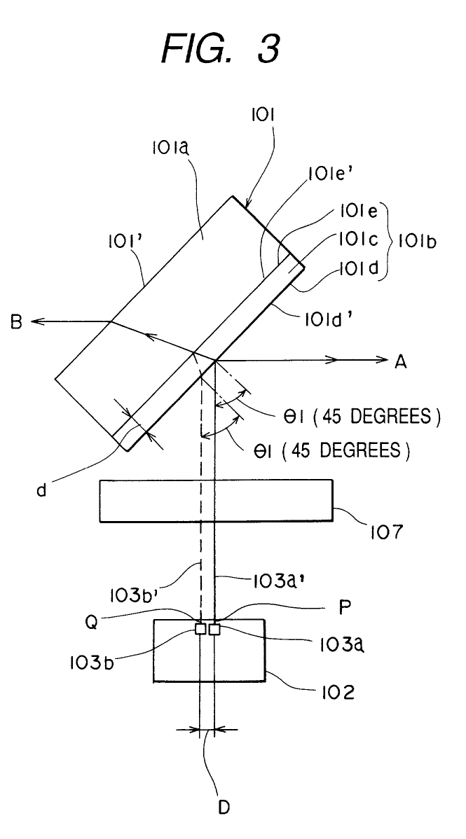

FIG. 1 illustrates the embodiment of an optical system 100 of the optical pickup relating to the invention, FIG. 2 is a partially sectional view of a two-wavelength laser diode 102, and FIG. 3 is a partially enlarged view of the part 3 in FIG. 1.

In FIG. 1, 101 denotes a beam splitter, and a light-receiving lens 104 and a light-receiving member 105 incorporating a light-receiving element (not illustrated) are disposed on one axis with a specific distance on one side of the beam splitter 101. Further, on the other side of the beam splitter 101 opposite to the light-receiving lens 104 is disposed a reflecting mirror 106.

Further, a diffraction grating 107 and one light-emitting part, namely, a two-wavelength laser diode 102 that emits laser beams of two different wavelengths, which are the first laser beam, a laser beam 103a′ for the DVD 62 and the second laser beam, a laser beam 103b′ for the CD 61, are coaxially disposed underneath the beam splitter 101, in a direction perpendicular to the optical axis connecting the light-receiving member 105 and the beam splitter 101. Further, a collimating lens 108 and an objective lens 109 are coaxially disposed above the reflecting mirror 106. Here, the objective lens 109 has a configuration that permits to handle the laser beams 103b′, 103a′ of two different wavelengths for the CD 61 and the DVD 62. Further, these optical members are mounted on a carriage not illustrated, and the like.

Next, the major components, namely, the two-wavelength laser diode 102 and the beam splitter 103 will be described in detail as to the configuration and the like.

First, as shown in FIG. 2, the two-wavelength laser diode 102 includes a disc-like base 102a, a rectangular base 102b projected from a plane 102a′ on one side of the base 102a, a laser chip 103 positioned and fastened onto a side wall of the base 102b, a cap 102e composed of a cylindrical body 102c fastened to the plane 102a′ anda top plate 102d having an opening 102d′ formed so as to embrace the base 102b, and a transparent disc-like glass plate 102f fastened from the inside of the cap 102e so as to cover the opening 102d′. Thus, the laser chip 103 is disposed in a space closed by the base 102a and the cap 102e and the glass plate 102f.

Further, the laser chip 103 has a light source 103a that emits a first laser beam for the DVD of a shorter wavelength (wavelength 650 nm band) and a light source 103b that emits a second laser beam for the CD of a longer wavelength (wavelength 780 nm band) formed adjacently to space a gap D. The first and the second laser beams 103a′, 103b′ that the light sources 103a, 103b each emit go out through the glass plate 102f to be in parallel with each other in a direction perpendicular to the plane 102a′ on one side of the base 102a. Although not illustrated, an external connection terminal is formed to project out from theothersideof the plane 102a′, through which drive currents, etc., are supplied to the laser chip 103.

In the manufacturing process of the two-wavelength laser diode 102, since a process resembling the semiconductor manufacturing process processes the laser chip 103 containing the two light sources 103a, 103b on a specific substrate, the gap D between the light sources 103a, 103b can easily be formed uniformly precisely with a specific value. Accordingly, the two-wavelength laser diode 102 can be manufactured in large quantities as a discrete component, and the cost thereof can be reduced.

Next, the beam splitter 101 functions to guide the laser beams 103b′, 103a′ from the two-wavelength laser diode 102 to the CD 61, DVD 62, respectively.

As shown in FIG. 3, the beam splitter 101 includes an optical plate, namely, a parallel plate 101a made of an optical glass having a specific refractive index and a wavelength-separating layer 101b formed on the parallel plate 101a. The wavelength-separating layer 101b has a first interface 101d and a second interface 101e that are disposed in parallel with each other, and a medium disposed between the first and second interfaces 101d, 101e, that is, an optical thin plate 101c made of the same material as the parallel plate 101a.

Here, the materials of the parallel plate 101a (optical plate) and the optical thin plate 101c (medium) each may be optical plastics, or may be a combination of an optical glass on one side and an optical plastic on the other side.

In this embodiment, the optical thin plate 101c is laminated onto the parallel plate 101a, and the laminated faces thereof form the second interface 101e, and the other side of the second interface 101e of the optical thin plate 101c forms the first interface 101d. Further, the optical thin plate 101c (medium) may be formed on the parallel plate 101a (optical plate) by the vapor deposition or the spattering method.

Further, the first and second interfaces 101d, 101e each have a first and second wavelength selecting films (dichroic films) 101d′, 101e′ coated thereon. The first wavelength selecting film 101d′ is formed so as to reflect the laser beam 103a′ for the DVD approximately by 50% and permeate it approximately by 50%, and so as to permeate the laser beam 103b′ for the CD substantially by 100%. Also, the second wavelength selecting film 101e′ is formed so as to permeate the laser beam 103a′ for the DVD substantially by 100%, and so as to reflect the laserbeam 103b′ for the CD approximately by 50% and permeate it approximately by 50%. Here, the first and second wavelength selecting films 101d′, 101e′ are formed by laminating to coat plural optical thin films each having specific optical characteristics.

Further, in this embodiment, assuming that the incident angle is θ1, the refractive index of the air is 1, the refractive index of the optical thin plate 101c is n2, and the thickness of the first and second wavelength selecting films 101d′, 101e′ is ignored because of their minuteness, the thickness d of the wavelength-separating layer 101b is given by the following expression.

d=D*√((n2)² −sin² θ1)/ sin (2*θ1) (formula 1)

Further, instead of the first and the second wavelength selecting films 101d′ , 101e′, a first and a second polarization separating films that reflect and permeate the laser beams 103a′, 103b′ by specific rates in accordance with the polarization states thereof may be formed on the first and the second interfaces 101d, 101e. Further, wavelength plates that transform each polarization states of the laser beams 103a′, 103b′ into each specific states may be added to the optical system 100.

Further, the beam splitter 101 is disposed in such amanner that the incident angle θ1 of the laser beam 103a′ (103b′) falling on the first interface 101d is 45°, and the light sources 103a, 103b are placed in parallel along the direction of the reflected light of the laser beam 103 a′.

In the beam splitter 101 thus formed, the laser beam 103a′ for the DVD reflects approximately by 50% on the first interface 101d. Here, the incident angle θ1 being 45°, the reflected light of the laser beam 103a′ reflects to form 90° from the incident light thereof. Further, the laser beam 103b′ for the CD permeates through the first interface 101d almost by 100%, advances with deflection into the optical thin plate 10c, and then reflects on the second interface 101e approximately by 50%. The reflected laser beam 103b′ advances into the optical thin plate 101c, and again deflects on the first interface 101d to go out from the beam splitter 101. In this case, since the thickness of the optical thin plate 101c is set to the d calculated by the formula 1, the laser beam 103b′ is on the same optical axis (the arrow A in the drawing) as the laser beam 103a′. Accordingly, the laser beams 103a′, 103b′ having emitted in the direction of the arrow A are returned from the optical disks, DVD 62, CD 61, and the return beams from the optical disks trace the path reverse to the arrow A on the same optical axis to again return to the beam splitter 101. The return beams permeate through the beam splitter 101 and advance in the direction of the arrow B in the drawing. Since the beam splitter 101 is formed in a parallel plate, the return beam fallen on the beam splitter 101 and the permeated beam (arrow B) after having permeated through the beam splitter 101 are in parallel.

Next, the reproducing operation of the CD 61 and the DVD 62 will be described.

When reproducing the CD 61, the laser beam 103b′ of a wavelength 780 nm that the light source 103b for the CD (refer to FIG. 2) emits passes through the diffraction grating 107. Then, the laser beam 103b′ with three beams formed by the diffraction grating 107 falls on the beam splitter 101. The incident laser beam 103b′ reflects about 50% on the beam splitter 101, deflects the angle thereof by 90°, and goes out from the beam splitter 101. The laser beam 103b′ falls on the reflecting mirror 106 disposed adjacently to the beam splitter 101, and deflects the angle with 90° to go out to the collimating lens 108. The laser beam 103b′ collimated by the collimating lens 108 falls on the objective lens 109. The objective lens 109 condenses the laser beam to form an image on the face of the CD 61 where data are recorded.

Thereafter, the laser beam (return beam) 103b′ reflected on the CD 61 permeates again through the objective lens 109 and the collimating lens 108, after reflecting on the reflecting mirror 106, permeates through the beam splitter 101 about 50%, and falls on the light-receiving lens 104. The light-receiving lens 104 transforms the return beam 103b′ into an optimum spot for the light-receiving element inside the light-receiving member 105 to receive, and then the return beam falls on the light-receiving member 105. Here, the return beam 103b′ received is converted into electricity by the light-receiving element, where a current output according to the signal on the data record face of the CD 61 is converted into a voltage signal, which is outputted as a reproduction signal from an external terminal not illustrated. Part of the return beam 103b′ received by the light-receiving element is used for the focusing control and the tracking control by the threebeam method.

On the other hand, when reproducing the DVD 62, the laser beam 103a′ of the wavelength 650 nm that the two-wavelength laser diode 102 emits, which is in parallel with the optical axis of the laser beams 103b′ with a specific distance (D), permeates through the diffraction grating 107, and falls on the beam splitter 101. The laser beam 103a′ fallen on the beam splitter 101 reflects about 50% to deflect the angle by 90° on the beam splitter 101, and goes out from the beam splitter 101. The laser beam 103a′ falls on the reflecting mirror 106 disposed adjacently to the beam splitter 101, and deflects the angle by 90° to go out to the collimating lens 108. The laser beam 103a′ collimated by the collimating lens 108 falls on the objective lens 109. The objective lens 109 condenses the laser beam to form an image on the face of the DVD 62 where data are recorded.

Thereafter, the laser beam (return beam) 103a′ reflected on the DVD 62 permeates again through the objective lens 109 and the collimating lens 108. After reflecting on the reflecting mirror 106, the return beam 103a′ permeates through the beam splitter 101 by about 50%, and falls on the light-receiving lens 104. After the light-receiving lens 104 transforms the return beam 103a′ into an optimum spot for the light-receiving element inside the light-receiving member 105 to receive, the return beam falls on the light-receiving member 105. Here, the return beam 103a′ received is converted into electricity by the light-receiving element, where a current output according to the signal on the data record face of the DVD 62 is converted into a voltage signal, which is outputted as a reproduction signal from an external terminal (not illustrated) of the light-receiving member 105. Part of the return beam 103a′ received by the light-receiving element is used for the focusing control and the tracking control.

According to this embodiment thus described, the optical system includes the two-wavelength laser diode 102 having two light sources 103a, 103b that emit the laser beam 103a′ for the DVD and the laser beam 103b′ for the CD, the light-receiving member 105, and the beam splitter 101. The beam splitter 101 is provided with the wavelength-separating layer 101b composed of the first and second interfaces 101d, 101e and the optical thin plate 101c between the interfaces, having the specific refractive index n2. The first and second interfaces bid, 101e each have the first and second wavelength selecting films l1ld′, 101e′ coated thereon, which reflect or permeate the laser beams 103a′, 103b′ each by the specific rates, bring the optical axes of the laser beams 103a′, 103b′ after having reflected on the first and second interfaces 101d, 101e into coincidence, permit the laser beams to go out of the beam splitter 101, and make the return beams from the optical disks permeate through the wavelength-separating layer 101b to guide them toward the light-receiving member 105. Thus, in the optical system using the light-emitting part having plural light sources, it is possible to bring the optical axes of the laser beams into coincidence by one beam splitter, to make the laser beams go out toward the optical disks from the beam splitter, and to thereby bring the optical axes of the return beams from the optical disks into coincidence. Therefore, it becomes possible to receive the return beams by one light-receiving element, to employ the widely generally used light-receiving member furnished with one light-receiving element as the light-receiving member, and accordingly to simplify the optical system using plural wavelengths into the same level as the one-wavelength optical system exclusive for the CD. Further, this system needs only one beam splitter, and it can employ the conventional light-receiving member, thus reducing the cost. Further, the position alignment of the light-receiving member is only needed for the alignment of the optical system, which simplifies the alignment process as well.

Further, the light-emitting part has two light sources that emit the first laser beam having the first wavelength and the second laser beam having the second wavelength, the wavelength-separating layer has the first interface and the second interface, the first and the second interfaces each have the first and the second wavelength selecting films formed thereon, which reflect or permeate the first and the second laser beams each by specific rates, the first interface reflects the first laser beam and permeates the second laser beam, the second interface reflects the second laser beam, and the first and the second interfaces permeate the first and the second laser beams, with regard to the return beams. Thereby, the optical system can be applied, for example, to an optical pickup for two wavelengths that can record or reproduce both the DVD and the CD (CD-R) . Further, since the wavelength-separating layer separates the first laser beam and the second laser beam and reflects them on the first interface and the second interface, the laser beams can be used efficiently.

Further, the first wavelength selecting film reflects the first laser beam approximately by 50%, permeates it approximately by 50%, and permeates the second laser beam almost by 100%, and the second wavelength selecting film permeates the first laser beam almost by 100%, reflects the second laser beam approximately by 50%, and permeates it approximately by 50%. The optical system being thus configured, the first laser beam and the second laser beam can be separated in a well-balanced state, and the laser beams can be used still more efficiently.

Further, the light-emitting part has two light sources that emit the first laser beam having the first wavelength and the second laser beam having the second wavelength, the wavelength-separating layer has the first interface and the second interface, and the first and the second interfaces each have the first and the second polarization separating films formed thereon, which reflect and permeate the first and the second laser beams in accordance with the polarization states thereof. Thereby, the optical system can be applied, for example, to an optical pickup for two wavelengths that can record or reproduce both the DVD and the CD (CD-R). Further, since the polarization separating films separate the first laser beam and the second laser beam and reflect them on the first interface and the second interface, the laser beams can be used efficiently.

Further, the beam splitter is composed of an optical plate and the wavelength-separating layer formed on the optical plate. Thereby, the wavelength-separating layer can be formed on the optical plate that a comparably simple process can easily form with a high precision, and it can be manufactured with a comparably low cost in comparison with the beam splitter formed in a cubic. Accordingly, the cost of the optical pickup can be reduced.

Further, the light-emitting part is a light-emitting member that contains plural light sources in one package. Thereby, a process resembling the semiconductor manufacturing process can process the light sources, and the light-emitting member can be manufactured in large quantities as a discrete component, and the cost thereof can be reduced. Accordingly, the cost of the optical pickup can be reduced.

Further, the diffraction grating is disposed between the light-emitting member and the beam splitter, whereby the laser beam can be transformed into the three beams. Therefore, the optical system can adopt the three-beams-tracking control being a suitable servo control for recording or reproducing the CD (CD-R), thereby achieving a stable recording and/or reproducing operation.

Further, the light-emitting member and the beam splitter each are fastened to a carriage separately, the interfaces are parallel with each other, the light-emitting member is placed in such a manner that the light sources are in a parallel direction with the surfaces of the optical disk, and the beam splitter is disposed in such a manner that the incident angles of the laser beams on the interfaces are virtually 45°. Thereby, the optical system using plural light sources can be made up mainly with one light-emitting member, one beam splitter, and one light-receiving member, and the optical system can take on the same configuration as the one-wavelength optical system using one light source exclusive for the CD, which simplifies the optical system, thereby reducing the cost. Further, the optical system can commonly employ the carriage used for the optical pickup of the conventional one-wavelength optical system, which saves a new designing of a carriage, thereby reducing the cost. Further, the optical system can employ the manufacturing facilities for the optical pickup of the conventional one-wavelength optical system as well, which spares a new provision of the manufacturing facilities, thereby reducing the cost. Further, since the light-emitting member and the light-receiving member is disposed to form 90° with the beam splitter as a base point, the light-emitting member and the light-receiving member can be placed close to the beam splitter, whereby the optical pickup can be made compact.

Further, the embodiment has been described in regard to the reproduction of the CD61 and the DVD 62, however the invention can naturally be applied to the recording of them.

Further, in the embodiment, the beam splitter 101 is composed of the parallel plate 101a with one wavelength-separating layer 101b stuck thereon, as shown in FIG. 3. However, the construction is not limited to this, and it may take more than two wavelength-separating layers laminated on the face of the parallel plate. Although this case needs more than three light sources, the invention displays the same effect. Also, it may take a structure such that two prisms are stuck in a cubic form and the wavelength-separating layer is formed between the two faces where the prisms are stuck.

What is claimed is:

1. An optical pickup comprising: a light-emitting part having plural light sources that emit laser beams of which wavelengths are different and optical axes are mutually parallel with a specific distance; a light-receiving member having a light-receiving element; and a beam splitter that admits the laser beams, delivers the laser beams toward optical disks, and guides return beams from the optical disks toward the light-receiving member where the light-receiving element receives the return beams, wherein:
the beam splitter is provided with a wavelength-separating layer,
the wavelength-separating layer is comprised of two interfaces and a medium having a specific refractive index, placed between the interfaces, or more than three interfaces and media each having specific refractive indexes, placed between the interfaces, and
the beam splitter reflects or permeates the laser beams at or through the interfaces, brings the optical axes of the laser beams after reflection into coincidence, delivers the laser beams out of the beam splitter, and permeates the return beams through the wavelength-separating layer to guide them toward the light-receiving member.

2. An optical pickup according to claim 1, wherein the light-emitting part has two light sources that emit a first laser beam having a first wavelength and a second laser beam having a second wavelength, the wavelength-separating layer has a first interface and a second interface, the first and the second interfaces each have a first and a second wavelength selecting films formed thereon, which reflect or permeate the first and the second laser beams each by specific rates, the first interface reflects the first laser beam and permeates the second laser beam, the second interface reflects the second laser beam, and the first and the second interfaces permeate the first and the second laser beams, with regard to the return beams.

3. An optical pickup according to claim 2, wherein the first wavelength selecting film reflects the first laser beam approximately by 50%, permeates it approximately by 50%, and permeates the second laser beam almost by 100%, and the second wavelength selecting film permeates the first laser beam almost by 100%, reflects the second laser beam approximately by 50%, and permeates it approximately by 50%.

4. An optical pickup according to claim 1, wherein the light-emitting part has two light sources that emit a first laser beam having a first wavelength and a second laser beam having a second wavelength, the wavelength-separating layer has a first interface and a second interface, and the first and the second interfaces each have a first and a second polarization separating films formed thereon, which reflect and permeate the first and the second laser beams in accordance with the polarization states thereof.

5. An optical pickup according to claim 1, wherein the beam splitter includes an optical plate and the wavelength-separating layer formed on the optical plate.

6. An optical pickup according to claim 1, wherein the light-emitting part is a light-emitting member contained in one package.

7. An optical pickup according to claim 6, wherein a diffraction grating is disposed between the light-emitting member and the beam splitter.

8. An optical pickup according to claim 6, wherein the light-emitting member and the beam splitter each are fastened to a carriage separately, the interfaces are parallel with each other, the light-emitting member is arranged in such a manner that the light sources are parallel with a direction along the surfaces of the optical disk, and the beam splitter is disposed in such a manner that the incident angles of the laser beams on the interfaces are virtually 45°.
